(19) United States
(12) Patent Application Publication
(10) Pub. No.: US 2021/0046709 A1
(43) Pub. Date: Feb. 18, 2021

(54) APPARATUS HAVING A CLIMATE CHAMBER ARRANGEMENT FOR EXECUTING A FUSED DEPOSITION MODELING METHOD

(71) Applicant: Röchling Automotive SE & Co. KG, Mannheim (DE)

(72) Inventor: Marco Barbolini, Bolzano (IT)

(21) Appl. No.: 16/986,416

(22) Filed: Aug. 6, 2020

(30) Foreign Application Priority Data
Aug. 12, 2019 (DE) 10 2019 121 658.3

(51) Int. Cl. B29C 64/364; B29C 64/118; B33Y 30/00; B33Y 40/00; B29C 64/25

(52) U.S. Cl. CPC B29C 64/364; B29C 64/118; B29C 64/25; B33Y 40/00; B33Y 30/00

(57) ABSTRACT

An apparatus for executing a fused deposition modeling method for constituting at least one component portion or component using a fusible construction material, encompassing: a layering tool for constituting at least the component portion or component by constituting layers of molten construction material in a predetermined pattern; a construction material manipulation portion; and a climate chamber arrangement; at least a sub-portion of the construction material manipulation portion being surrounded by a climate chamber arrangement portion of the climate chamber arrangement; the climate chamber arrangement being configured to adjust, at least locally, a climate parameter in an interior of the climate chamber arrangement portion; and the apparatus being configured to perform a manipulation of the construction material in the climate chamber arrangement portion, wherein the climate parameter is a humidity of an internal gas medium in the interior of the climate chamber arrangement portion.

This Application claims priority in German Patent Application DE 10 2019 121 658.3 filed on Aug. 12, 2019, which is incorporated by reference herein.

The present invention relates to an apparatus for executing a fused deposition modeling method. One known representative of the fused deposition modeling method is the trademark-protected FDM method developed by the Stratasys company, which is also known as a “fused filament fabrication” (FFF) method. Other representatives of the fused deposition modeling method are based on the application of fused droplets to form layers, rather than application of molten filaments as is usual in FFF methods.

### BACKGROUND OF THE INVENTION

When a component is constituted using a fused deposition modeling method, droplets or filaments of a molten construction material are repeatedly applied, in part superimposedly onto one another, onto a work surface using a layering tool, for example an extruder head having a nozzle. These droplets or filaments remain in the desired position after cooling, either due to adhesion to the work surface or by adhesion onto construction material that has already been previously applied. The construction material is usually extruded in one working step at a specified height above the work surface, and only after application of the layer resulting therefrom has been completed is a further layer applied in a corresponding manner onto the already existing layer, so that the component is constituted in layers. In apparatuses that are usual at present, a component of this kind is constituted in a heating chamber in order to reduce, by way of a heat treatment, the stress that occurs between the various layers during constitution of the component.

When engineering plastics, such as polyamide (PA), are used as construction material, the moisture content, characterized e.g. as the water concentration, of the construction material being used is critical in terms of the properties of the component that is manufactured. For that reason, the construction material is preferably desiccated before it is delivered to an apparatus for executing a fused deposition modeling method. It is to be noted in this context that constitution of a complex component can routinely take several days, and that climate parameters such as temperature and humidity can change significantly during that time. But because moisture uptake in the component and/or in the construction material that is used is temperature-dependent, the completed component can thus exhibit a different moisture content and thus different material properties, such as density, at locations that were constituted at different times. Moisture uptake during constitution of the complex component can result in component dimensions that deviate from specifications, and in greater stress in the component. These problems occur particularly often when the construction material is stored in the open air and is thus directly exposed to changes in the temperature and humidity of the air. The resulting changes in the material properties of the component can often require that production of such a component be discontinued, either because the material properties in the component have changed sufficiently that the requisite component specifications can no longer be complied with, or because the production parameters have changed, due to the varying moisture content of the construction material, to such an extent that a permissible control range of the apparatus for at least one of those production parameters has been reached, and production can no longer be successfully continued.

At present, the temperature of the heating chamber is selected so as to establish a compromise between material properties and production parameters, for example the internal temperature in the heating chamber at the production site, humidity at the production site, application rate of the construction material or a temperature of the molten construction material, etc.

### SUMMARY OF THE INVENTION

An object of the present invention is therefore to furnish an apparatus for executing a fused deposition modeling method with which improved material properties of a component or component portion, constituted therein using the fused deposition modeling method, are achieved.

This object is achieved according to the present invention by an apparatus according to Claim 1. Preferred embodiments of the invention are described in the dependent claims.

The invention furnishes, in particular, an apparatus for executing a fused deposition modeling method for constituting at least one component portion or component using a fusible construction material, encompassing: a layering tool for constituting at least the component portion or component by constituting layers of molten construction material in a predetermined pattern; a construction material manipulation portion; and a climate chamber arrangement; at least a sub-portion of the construction material manipulation portion being surrounded by a climate chamber arrangement portion of the climate chamber arrangement; the climate chamber arrangement being configured to adjust, at least locally, a climate parameter in an interior of the climate chamber arrangement portion; and the apparatus being configured to perform a manipulation of the construction material in the climate chamber arrangement portion, the climate parameter being a humidity of an internal gas medium in the interior of the climate chamber arrangement portion. An “internal gas medium” is in particular a gas or gas mixture that is present in the interior of the climate chamber arrangement portion or of a further climate chamber arrangement portion. An adjustment of a climate parameter is performed in particular by way of a control operation performed by a control unit or regulation unit of the climate chamber. As a result of the adjustment of the humidity of the internal gas medium in the interior of the climate chamber arrangement portion, the moisture content of the construction material is positively influenced. This can be the moisture content of the construction material before delivery to the layering tool, but also the moisture content of the construction material in the component or component portion, since an uptake of moisture by the construction material also takes place during the time during which the component or component portion is being constituted. The result of adjusting the humidity of the internal gas medium is that material properties of the component or component portion are improved. For adjustment of a climate parameter, it is the case in particular that it can be adjusted to a selected value by the fact that the selected value is inputted, transferred, or the like as an input into a regulating unit and/or control unit, and that the regulating unit and/or control unit uses that input, together with a predetermined characteristic curve, to modify the behavior of the climate chamber arrangement in terms of the climate parameter. If a temperature of 50° is inputted, for example, as a selected value, a heat output can then be read off via a characteristic curve and the climate chamber arrangement can be instructed to heat using that heat output. If a humidity of an internal gas medium of 3 g/m³ is inputted, for example, as a selected value, then via a characteristic curve a capacity utilization of a dehumidifier, with respect to its maximum capacity for the internal gas medium, can be read off, and the climate chamber arrangement can be instructed to operate the dehumidifier at that capacity utilization.

The layering tool can be, in particular, an extruder head or the nozzle thereof. It is preferred that the layering tool be capable of being displaced in all three spatial directions under the regulation and/or control of a regulating unit or control unit. The predetermined pattern can be determined in usual fashion on the basis of a breakdown of a three-dimensional model of the component or component portion into its section contours. The sub-portion of the construction material manipulation portion is, in particular, a space occupied at least temporarily by construction material during manipulation of construction material.

The climate chamber arrangement can encompass a single climate chamber, or a plurality of climate chambers separated at least by a respective wall, or a single climate chamber having a plurality of climate zones that can each encompass or embody the climate chamber arrangement portion or a further climate chamber arrangement portion. The climate chamber arrangement portion can be embodied as an inner sub-volume of the climate chamber arrangement which is surrounded in particular by a wall. The climate chamber arrangement portion is, in particular, different from a compressor and/or a dehumidifier and/or a heat exchanger and/or a heating device and/or a fan and/or an auxiliary unit of the climate chamber arrangement.

The climate chamber arrangement can be constituted by a single climate chamber, or by a plurality of climate chambers separated at least by a respective wall, or by a single climate chamber having a plurality of climate zones that can each encompass or embody the climate chamber arrangement portion or a further climate chamber arrangement portion. A climate chamber arrangement encompasses in particular a climate-control region, encompassing the climate chamber arrangement portion and/or the or each further climate chamber arrangement portion, in which the climate chamber can adjust or regulate at least one or a plurality of climate parameters.

Unless indicated to the contrary in the description, the statements in this Application regarding the climate chamber arrangement portion are also to be applied to the further climate chamber arrangement portion of the climate chamber arrangement. The climate chamber arrangement can comprise, in particular in each of its climate chamber arrangement portions, sensors for detecting climate parameters and optionally a control unit and/or regulating unit that adjusts respective climate parameters such as the temperature and humidity of the internal gas medium and/or regulates them to predetermined associated climate parameter setpoints on the basis of signals detected by the sensors. Those sensors can be apparatus parameter sensors.

The climate chamber arrangement is preferably arranged in an interior of the apparatus for executing a fused deposition modeling method; media such as cooling water or energy to be supplied to the climate chamber arrangement can be delivered to the apparatus from outside the apparatus for execution of a fused deposition modeling method. The climate chamber arrangement is preferably different from a climate-control unit of a room in which the apparatus is installed. The apparatus for executing a fused deposition modeling method can encompass an external housing that is preferably different from a building room wall of a room in which the apparatus for execution of a fused deposition modeling method is installed, and the climate chamber arrangement is preferably provided in an interior of the external housing; media such as cooling water or energy to be supplied to the climate chamber can be delivered to the apparatus from outside the apparatus.

In a particularly preferred embodiment, the climate chamber arrangement is configured to adjust, at least locally, at least one further climate parameter, preferably a plurality of further climate parameters, in the interior of the climate chamber arrangement portion; particularly preferably, the climate chamber arrangement is configured to regulate at least one of and/or a plurality of and/or each of the climate parameters and/or further climate parameters adjusted in the interior of the climate chamber arrangement portion respectively to an associated climate parameter setpoint, such that each of the climate parameter setpoints can have a value that can differ from the value of the associated climate parameter outside the climate chamber arrangement portion, preferably outside the climate chamber arrangement. In particular, the humidity of the internal gas medium is a climate parameter. Such a functionality is preferably not limited only to the one climate chamber arrangement portion, so that in a preferred embodiment the climate chamber arrangement encompasses a further climate chamber arrangement portion and in particular is configured to adjust one and/or a plurality of climate parameters in the interior of the further climate chamber arrangement portion; particularly preferably, the climate chamber arrangement is configured to regulate at least one of and/or a plurality of and/or each of the climate parameters and/or further climate parameters adjusted in the interior of the further climate chamber arrangement portion respectively to an associated climate parameter setpoint, such that each of the climate parameter setpoints can have a value that can differ from the value of the associated climate parameter outside the further climate chamber arrangement portion, preferably outside the climate chamber arrangement. When a climate parameter or a further climate parameter is regulated it is, in particular, also adjusted.

When further climate parameters, in particular a temperature of the internal gas medium, are adjusted in the interior of the climate chamber arrangement portion, the moisture content of the construction material can be adjusted particularly accurately. If at least one climate parameter in the interior of the further climate chamber arrangement portion is adjusted, the moisture content of the construction material can then be adjusted over wide handling ranges for the construction material in the apparatus. In the interior of the further climate chamber arrangement portion as well, it is preferred that both the temperature and the humidity of the internal gas medium be adjusted as climate parameters. Thanks to the transition from adjustment to regulation, in the interior both of the climate chamber arrangement portion and of each further climate chamber arrangement portion, the respective climate parameters therein can be regulated to desired setpoints, with the result that the moisture content of the construction material once again not only can be positively influenced but also can be regulated to a desired value within the range of what is technically possible. This once again results in constant and improved material properties of the component or component portion.

A “manipulation” of the construction material is understood in particular as, individually or in combination, storage and/or desiccation and/or adjustment of the moisture content of and/or regulation of the moisture content of and/or transportation and/or reshaping and/or melting and/or extrusion of the construction material, and/or constitution of a semi-finished product from the construction material, and/or application of the molten construction material in a predetermined pattern. If the construction material is stored in a climate chamber arrangement portion during or before constitution of the component or component portion in the apparatus, the moisture content in the construction material can be held constant over the storage time period. Alternatively or additionally, the material can be exposed, in the climate chamber arrangement portion, to conditions, such as temperature in the climate chamber arrangement portion and/or humidity of the internal gas medium in the climate chamber arrangement portion, in which a desiccation of the construction material, which has a positive effect on the material properties of the component or component portion, takes place. With a suitable selection of regulation or control of the temperature in the climate chamber arrangement portion and/or of the humidity of the internal gas medium in the climate chamber arrangement portion, in contrast to desiccation, the humidity can not only be reduced but adjusted or regulated to a desired value that has an influence on the material properties of the component or component portion, “adjustment” of the humidity being understood in this Application as an unregulated process. During transportation of the construction material, the temperature in the climate chamber arrangement portion and/or the humidity of the internal gas medium in the climate chamber arrangement portion can be regulated and/or controlled in such a way that the construction material has the desired moisture content at the location at which the fused deposition modeling method is executed. If a semi-finished product, for example a filament, is constituted from the construction material for use during the fused deposition modeling method to be executed by the apparatus, it is also advantageous, mutatis mutandis, to regulate or control, at the location where the semi-finished product is constituted, the temperature in the climate chamber arrangement portion and/or the humidity of the internal gas medium in the climate chamber arrangement portion, in order to obtain a desired moisture content of that semi-finished product. The same applies if the construction material is reshaped, melted, extruded, or applied in a predetermined pattern during the layering method.

The aforesaid advantages can be achieved in a particularly simple manner if the climate parameter or the further climate parameter, or each individual one of a plurality of or each individual one of the climate parameters or further climate parameters, is respectively selected from: humidity of the internal gas medium in the interior of the climate chamber arrangement portion or of the further climate chamber arrangement portion; temperature in the interior of the climate chamber arrangement portion or of the further climate chamber arrangement portion; pressure of the internal gas medium in the interior of the climate chamber arrangement portion or of the further climate chamber arrangement portion; and composition of the internal gas medium in the interior of the climate chamber arrangement portion or of the further climate chamber arrangement portion. Due to simplicity of implementation, the internal gas medium and/or the external gas medium is, in this Application, preferably air. In order to achieve particularly high quality in the component or component portion, for instance by avoiding oxidation in the context of manufacture, the internal gas medium can be, in this Application, an inert-gas mixture or an inert gas, for instance nitrogen. The climate parameter setpoints can be determined experimentally in order to obtain optimal material properties and production parameters.

In particular, the climate chamber arrangement portion or each of the further climate chamber arrangement portions can be configured to regulate, upon constitution of the component portion or of the component, at least one of, preferably each of, the regulated or adjusted climate parameters to a production climate parameter setpoint, and to adjust and/or regulate, during a preparation phase of the constitution of the component portion or of the component, at least one of, preferably each of, the regulated or adjusted climate parameters to a preparation climate parameter setpoint that is preferably different from the corresponding production climate parameter setpoint. The production climate parameter setpoints and/or the preparation climate parameter setpoints can be stored in a regulating unit and/or control unit that effects control and/or regulation of the respective climate parameter in the interior of the climate chamber arrangement portion.

In the apparatus, the construction material manipulation portion can encompass a construction material storage portion for storing the construction material, or a semi-finished product produced therefrom, as a starting material for use for the fused deposition modeling method; and/or can encompass a component production portion furnishing a space for constituting the component portion or the component, in which the component portion or the component is constituted using the fused deposition modeling method utilizing the layering tool and the construction material; and preferably can encompass a construction material transfer portion that is arranged between the construction material storage portion and the component production portion and is configured for transportation of the construction material, or of the semi-finished product produced therefrom, between the construction material storage portion and the component production portion; these, each individually or in any combination, can constitute the sub-portion of the construction material manipulation portion.

If the component production portion, constituting a sub-portion of the construction material manipulation portion, is surrounded by the climate chamber arrangement portion, or by a further climate chamber arrangement portion, of the climate chamber arrangement, the climate parameters, such as a temperature in the interior of that climate chamber arrangement portion and/or a humidity of the internal gas medium in the interior of that climate chamber arrangement portion, can then be regulated and/or controlled in such a way that a sintering process can occur between the individual layers applied during the fused deposition modeling process and/or between adjacent portions of an individual layer that have been applied next to one another with an offset in time. Improved connections between the individual layers, or within the layer, can thereby be achieved.

If the construction material storage portion, constituting a sub-portion of the construction material manipulation portion, is surrounded by the climate chamber arrangement portion, or by a further climate chamber arrangement portion, of the climate chamber arrangement, the climate parameters, such as a temperature in the interior of that climate chamber arrangement portion and/or a humidity of the internal gas medium in the interior of that climate chamber arrangement portion, can then be regulated and/or controlled in such a way that the moisture content of the construction material is adjusted to a desired value, preferably held constant, throughout the constitution of the component or of the component portion. This results in an improvement in the material properties of the construction material and of the component or component portion. It is likewise possible to dispense with a separate apparatus for desiccating the construction material, since desiccation of the construction material can begin as soon as that material is introduced into the construction material storage portion. As soon as the material has reached the desired desiccation level, that level can be held constant in the construction material storage portion using the climate chamber arrangement portion, thereby eliminating the uncertainty with regard to the moisture content of the construction material which occurs if the desiccated construction material is stored on the apparatus in a non-climate-controlled environment.

If the construction material transfer portion, constituting a sub-portion of the construction material manipulation portion, is surrounded by the climate chamber arrangement portion, or by a further climate chamber arrangement portion, of the climate chamber arrangement, the climate parameters, such as a temperature in the interior of that climate chamber arrangement portion and/or a humidity of the internal gas medium in the interior of that climate chamber arrangement portion, can then be selected, by regulation and control of those parameters, so as to prevent the moisture content of the construction material from changing upon transportation from the construction material storage portion into the component production portion.

Because a construction material having a defined, preferably constant, moisture content is furnished, it is possible for production parameters to require little modification during production in order to be able to react to changes in the environmental conditions of the apparatus; in particular, the production parameters can be held constant in many cases, with the result that material properties of the component or component portion can in turn be held constant at a high level.

It is preferred in particular that the component production portion and/or the construction material storage portion and/or the construction material transfer portion be surrounded by the climate chamber arrangement portion, or by a further climate chamber arrangement portion, of the climate chamber arrangement.

In a particularly preferred embodiment, the interior of the preferably separately embodied climate chamber arrangement portion, or the interior of a further, preferably separately embodied climate chamber arrangement portion, for instance the interior of a climate chamber or the interior of the entire climate chamber arrangement, is limited to the component production portion and/or construction material storage portion and/or construction material transfer portion, limitation to the component production portion being preferred.

In order to isolate from the environment the location at which the fused deposition modeling method is executed, and to enable simple removal of the constituted component portion or component such that the climate parameters in the component production portion are negatively influenced only briefly, it is preferred that the component production portion be surrounded by the climate chamber arrangement portion, or by a further climate chamber arrangement portion, of the climate chamber arrangement, that climate chamber arrangement portion having a wall that comprises a reopenable and reclosable removal opening for removing the constituted component portion or constituted component from that climate chamber arrangement portion.

The component production portion can furthermore be surrounded by the climate chamber arrangement portion, or by a further climate chamber arrangement portion, of the climate chamber arrangement, that climate chamber arrangement portion comprising a wall that comprises a construction material delivery opening, the construction material delivery opening being configured to permit transportation of construction material into an interior of that climate chamber arrangement portion and to prevent transportation of the internal gas medium from the interior of that climate chamber arrangement portion into its exterior space from which it is separated by the wall, and to prevent transportation of an external gas medium from its exterior space into the interior of that climate chamber arrangement portion, preferably using a sealing apparatus, in particular a flexible seal, particularly preferably an O-ring. The external gas medium can be air. The internal gas medium can be air or an inert-gas mixture or inert gas, for instance nitrogen.

Prevention of transportation of an internal gas medium from the interior of that climate chamber arrangement portion into its exterior space, from which it is separated by the wall, is understood to mean any effect of the sealing apparatus which results in a reduction of a flow, e.g. mass flow, of the internal gas medium from the interior of the climate chamber arrangement portion into its exterior space, compared with the case in which the sealing apparatus is removed or withdrawn. Prevention of transportation of an external gas medium from the exterior space into the interior of that climate chamber arrangement portion is to be understood as any effect of the sealing apparatus which results in a reduction of a flow, e.g. mass flow, of the external gas medium from the exterior space into the interior of that climate chamber arrangement portion, compared with the case in which the sealing apparatus is removed or withdrawn. The sealing apparatus can be embodied, for instance, as an O-ring abutting both against the wall and against a construction material used in the form of a filament.

In order to allow the apparatus to be repeatedly loaded with construction material without long-term negative influence on the climate parameters in the construction material storage portion, the construction material storage portion is surrounded by the climate chamber arrangement portion, or by a further climate chamber arrangement portion, of the climate chamber arrangement, that climate chamber arrangement portion having a wall that comprises a reopenable and reclosable loading opening for loading the construction material storage portion with construction material.

In a preferred embodiment, the construction material storage portion is surrounded by the climate chamber arrangement portion, or by a further climate chamber arrangement portion, of the climate chamber arrangement, that climate chamber arrangement portion having a wall that comprises a construction material discharge opening, the construction material discharge opening being configured to permit transportation of construction material from an interior of that climate chamber arrangement portion and to prevent transportation of the internal gas medium from the interior of that climate chamber arrangement portion into its exterior space from which it is separated by the wall, and to prevent transportation of an external gas medium from its exterior space into the interior of that climate chamber arrangement portion, preferably using a sealing apparatus, in particular a flexible seal, particularly preferably an O-ring. In this Application, the external gas medium can be air. In this Application, the internal gas medium can be air or an inert gas or inert-gas mixture, for instance nitrogen. Because transportation of the internal gas medium from the interior of that climate chamber arrangement portion is prevented, and because transportation of an external gas medium into the interior of that climate chamber arrangement portion is prevented, the parameters required in order to achieve the desired moisture content of the construction material, such as the temperature in the interior of that climate chamber arrangement portion and/or humidity of the internal gas medium in the interior of that climate chamber arrangement portion, can thereby be maintained in particularly simple fashion.

It is preferred that the construction material be an engineering plastic, in particular a thermoplastic, particularly preferably a polyamide (PA), although it is also conceivable to use polyethylene, polylactide, PETG, thermoplastic elastomers, or acrylonitrile-butadiene-styrene as construction materials.

In order to increase the probability of successful execution of a fused deposition modeling method, or to allow the fused deposition modeling method to be discontinued as quickly as possible if it is assumed to have failed, the apparatus preferably encompasses a regulating unit and/or control unit for regulating and/or controlling the execution of the fused deposition modeling method, and at least one apparatus parameter sensor configured for direct or indirect transfer of an apparatus parameter, detected by it, to the regulating unit and/or control unit, the regulating unit and/or control unit being configured to compare each of the transferred apparatus parameters with a predetermined setpoint range for that apparatus parameter, and to prevent the fused deposition modeling method from beginning, and/or to interrupt the fused deposition modeling method, if one of the transferred apparatus parameters is outside the setpoint range for that apparatus parameter. These setpoint ranges can be determined experimentally in order to obtain optimal material properties and production parameters. An “indirect” transfer of an apparatus parameter to the regulating unit and/or control unit is, in particular, a transfer of the apparatus parameter via at least one intermediate station, e.g. a further regulating unit and/or control unit. Apparatus parameters can be, inter alia, climate parameters existing in the interior of the apparatus, in particular in the interior of the climate chamber arrangement portion.

Because the temperature and humidity of the internal gas medium at the location of the construction material are climate parameters crucially responsible for desiccation of the construction material and for regulation and/or control of the moisture content of the construction material, and since regulation and/or control of them thus crucially governs the material properties exhibited by the component or component portion manufactured using the fused deposition modeling method, it is preferred that the apparatus parameter sensor be a hygrometer, and that the associated apparatus parameter be the humidity of the internal gas medium in the climate chamber arrangement portion, or in a further climate chamber arrangement portion, of the climate chamber arrangement; and/or that the apparatus parameter sensor be a thermometer, and that the associated apparatus parameter be the temperature in the climate chamber arrangement portion, or in a further climate chamber arrangement portion, of the climate chamber arrangement.

In order to allow the moisture content of the construction material to be checked in situ, it is preferred that the apparatus parameter be the moisture content of the construction material, and that the apparatus parameter sensor be a moisture content determiner or an absolute moisture content determiner.

In order to counteract incorrect operation of the apparatus, which has a negative effect on a temperature and/or a humidity of the internal gas medium in the region where the construction material is handled, it is preferred that the apparatus parameter be a closure state parameter of the removal opening, which parameter has a value of “closed” when the removal opening is in a closed state and a value of “not closed” when the removal opening is not in a closed state; and that the apparatus parameter sensor be a closure state sensor, for example a contact switch, the setpoint range of the closure state parameter preferably comprising only the value of “closed.” For the same purpose, it can be preferred that the apparatus parameter be a closure state parameter of the loading opening, which parameter has a value of “closed” when the loading opening is in a closed state and a value of “not closed” when the loading opening is not in a closed state; and that the apparatus parameter sensor be a closure state sensor, for example a contact switch, the setpoint range of that closure state parameter preferably comprising only the value of “closed.”

Be it noted at this juncture that the apparatus can detect a plurality of the aforementioned apparatus parameters by means of a plurality of respectively associated apparatus parameter sensors of the apparatus. The apparatus can correspondingly encompass any combination of the individual apparatus parameter sensors for detecting the apparatus parameters using associated apparatus parameter sensors. The detected apparatus parameters are compared, by the control unit, with the respective predetermined setpoint range for the respective apparatus parameter, and the result of the comparison is, as applicable and as described above, to prevent the fused deposition modeling method from beginning, or to interrupt the fused deposition modeling method.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 is a schematic view of a first embodiment of the present invention;

FIG. 2 is a schematic view of a second embodiment of the present invention; and

FIG. 3 is a schematic view of a third embodiment of the present invention.

### DESCRIPTION OF PREFERRED EMBODIMENTS

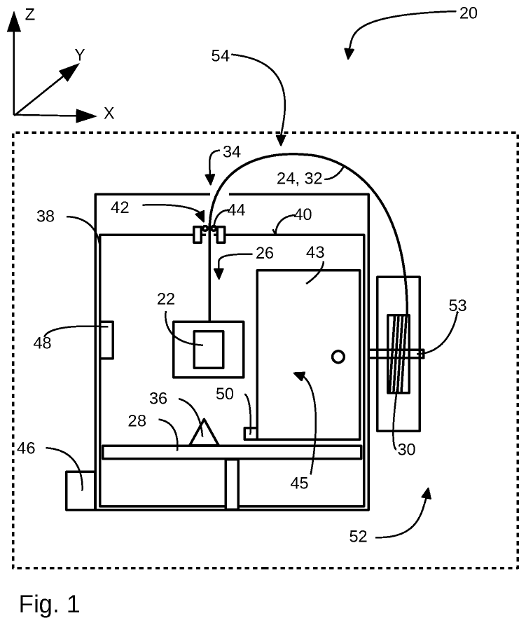

Referring now to the drawings wherein the showings are for the purpose of illustrating preferred and alternative embodiments of the invention only and not for the purpose of limiting the same, a first embodiment of the present invention will be described below with reference to FIG. 1.

FIG. 1 shows an apparatus 20 for executing a fused deposition modeling method for constituting a component or a component portion. Apparatus 20 encompasses a layering tool, for instance an extruder head 22. In the description hereinafter, no distinction will be made between a component and a component portion, since the constitution thereof proceeds in substantially the same manner, and statements made for the component also apply to the component portion. A component portion can, however, in particular be a component part, constituted in particular using a fused deposition modeling method, that is not completely embodied using a fused deposition modeling method. Extruder head 22 is arranged on an XYZ displacement unit (not depicted), so that its nozzle that outputs a strand of molten construction material 24 can be moved within a component production portion 26 of apparatus 20 respectively in the X, Y, and Z direction. Extruder head 22 firstly, by means of the molten strand, builds up a layer of construction material onto a working surface 28 and, as the method proceeds, builds up further layers onto that first layer by means of the molten strand. The predetermined pattern in which the construction material is built up is predetermined by the fact that a model of the component to be constituted is broken down into section contours, and those section contours, as is usual in the FFF method, then serve as a basis for applying control to extruder head 22. Construction material 24 is furnished on a spool 30 in the form of a filament 32 that is produced, for example, from polyamide. Filament 32 can pass through an opening 34 into a region of apparatus 20 which is surrounded by a housing. Provided therein is a component production portion 26 of apparatus 20, in which portion component 36 that is to be constituted is constituted. In the first embodiment, this region is surrounded by a climate chamber 38 that, in this embodiment, constitutes an entire climate chamber arrangement. This climate chamber, like each climate chamber described below, can adjust or regulate to a setpoint the temperature and humidity of the air constituting an internal gas medium in its interior.

Climate chamber 38 preferably surrounds extruder head 22, working surface 28, and the XYZ displacement unit (not depicted). It is preferred that filament 32 be sealed upon entry into climate chamber 38, with respect to a wall 40 of climate chamber 38, by a construction material delivery opening 42 in wall 40, in particular using an O-ring 44, so that air, constituting an internal gas medium and external gas medium, substantially cannot be transported between an interior of climate chamber 38 and its exterior. If O-ring 44 were removed, then a mass flow of air which is greater because of diffusion would pass through construction material delivery opening 42 because of the resulting larger open cross-sectional area of construction material delivery opening 42, so that O-ring 44 prevents transportation of air into and from the interior of climate chamber 38.

Climate chamber 38 preferably encompasses a regulating unit or control unit 46 and a sensor arrangement 48 that preferably comprises a sensor for measuring a temperature in the interior of climate chamber 38 and a sensor, e.g. a hygrometer, for measuring a humidity in the interior of climate chamber 38. Each of the sensors of sensor arrangement 48 is preferably connected (not shown) to the regulating unit or control unit in order to transfer the respective measured values. Those measured values are compared by regulating unit or control unit 46 with predetermined respective setpoints inputted, for instance, manually by a user, and regulating unit or control unit 46 correspondingly applies control to climate chamber 38 in order to arrive at the humidity setpoint and temperature setpoint in the interior of climate chamber 38. Regulating unit or control unit 46 furthermore regulates or controls the execution of the fused deposition modeling method. Execution of the fused deposition modeling method can, however, also be regulated and/or controlled in a separate unit.

Climate chamber 38 preferably comprises, in wall 40, a removal opening 45 which is reopenable and reclosable by way of a door 43 and which, in its closed state, is sealed with respect to wall 40, preferably by a rubber lip. Preferably arranged on removal opening 45 is a contact switch 50 which is connected to regulating unit or control unit 46 and which, for instance, when removal opening 45 is closed by door 43, creates a conductive connection between two of its terminals and severs that connection when removal opening 45 is opened. Regulating unit or control unit 46 is preferably configured to detect this conductivity state of contact switch 50 and to assign a value of “closed” to the closure state parameter of that contact switch 50 when the conductive connection exists, and otherwise to assign to it a value of “not closed.” This represents a special form of transferring an apparatus parameter to regulating unit or control unit 46.

Contact switch 50, as well as the temperature sensor and humidity sensor of sensor arrangement 48, each constitute an apparatus parameter sensor that transfers the respective apparatus parameters to regulating unit or control unit 46, which is configured to compare each of those apparatus parameters with a setpoint range, predetermined e.g. by a user by input, for that apparatus parameter. The setpoint ranges can be determined experimentally in order to obtain optimal material parameters for the component and optional production parameters. If at least one of those apparatus parameters is outside the predetermined setpoint range for that apparatus parameter, regulating unit or control unit 46 is preferably configured to prevent the fused deposition modeling process from beginning, or to stop a fused deposition modeling process that has already started.

Spool 30 is arranged in a construction material storage portion 52 of apparatus 20; and upon passing from construction material storage portion 52 to component production portion 26, construction material 24 passes through a construction material transfer portion 54 of apparatus 20 through which construction material 24 is transferred from construction material storage portion 52 into component production portion 26. Construction material storage portion 52 preferably encompasses a holder 53 for spool 30. Construction material transfer portion 54 can encompass a guide for filament 32 which can be embodied as a flexible tube or flexible hose, e.g. a Teflon hose, which is preferably stiffened with inlays, e.g. wires.

Alternatively to the embodiment described, the entire apparatus 20 can be provided in a single climate chamber (depicted with dashed lines in FIG. 1) constituting a climate chamber arrangement.

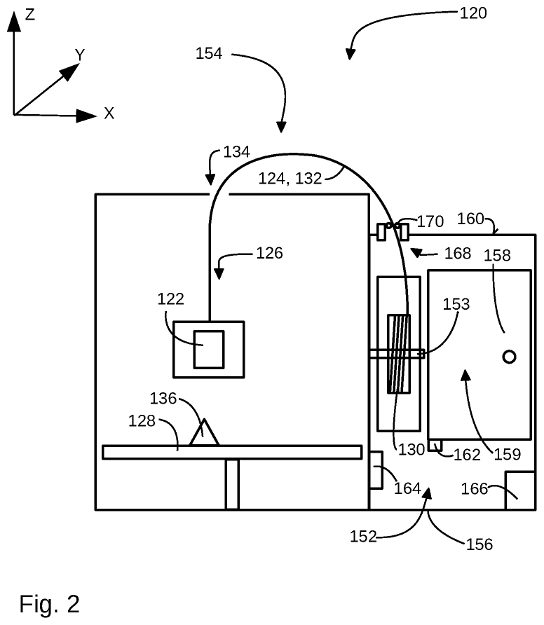

A second embodiment of the present invention will be described below with reference to FIG. 2. Only the differences between the second embodiment and the first embodiment will be discussed here. Identical or similar components are each labeled, in FIG. 2 and in the description of the second embodiment, with reference characters incremented by 100, and reference is explicitly made to their description in the first embodiment unless otherwise indicated by the description.

The second embodiment differs from the first embodiment in that component production portion 126 is not surrounded by a climate chamber, but a climate chamber 156 does surround construction material storage portion 152.

Climate chamber 156 comprises a door 158 that reopenably and reclosably closes off a loading opening 159. Door 158 is preferably sealed with a sealing lip (not shown) with respect to a wall 160 of climate chamber 156. Through door 158, an empty spool 130 can be removed and replaced with a spool 130 carrying a further filament 132. A contact switch 162 is once again arranged on door 158. Climate chamber 156 comprises a sensor arrangement 164 having a temperature sensor and a humidity sensor each in the interior of climate chamber 156, as well as a regulating unit or control unit 166 that regulates or controls the execution of the fused deposition modeling method. The operation of regulating unit or control unit 166 in interaction with contact switch 162, climate chamber 156, and the sensors of sensor arrangement 164 corresponds to the operation of regulating unit or control unit 46 in interaction with contact switch 50, climate chamber 38, and the sensors of sensor arrangement 48. In particular, if one of the detected apparatus parameters (see statements with regard to the first embodiment) is outside the predetermined setpoint range, regulating unit or control unit 166 is preferably configured to prevent the fused deposition modeling process from beginning or to stop a fused deposition modeling process that is already running. Contact switch 162, as well as the temperature sensor and the humidity sensor of sensor arrangement 164, each constitute an apparatus parameter sensor that transfers the respective apparatus parameters to regulating unit or control unit 166.

Also provided on wall 160 of climate chamber 156 is a construction material discharge opening 168 from which filament 132 emerges out of climate chamber 156 into construction material transfer portion 154. Filament 132 is sealed in construction material discharge opening 168 with respect to an exterior of climate chamber 156, in particular using an O-ring 170, so that air, constituting an internal gas medium and external gas medium, substantially cannot be transported between an interior of climate chamber 156 and its exterior. The statements made with regard to the function of O-ring 44 in construction material delivery opening 42 in the first embodiment apply correspondingly to O-ring 170 in construction material discharge opening 168, so that O-ring 170 prevents transportation of air as the gas medium.

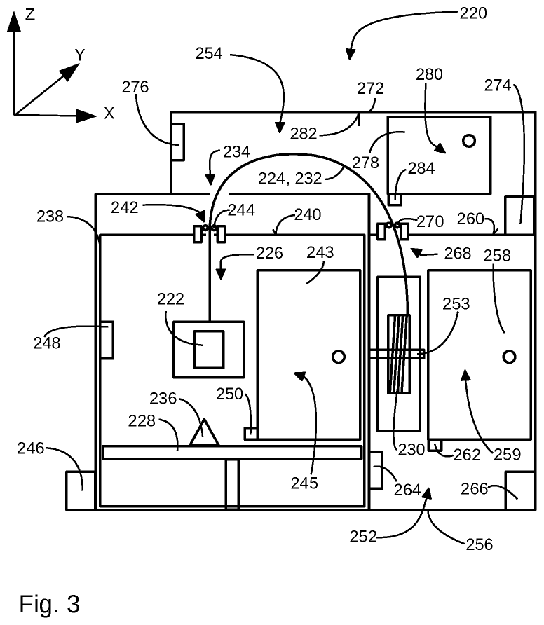

A third embodiment of the present invention will be described below with reference to FIG. 3. Only the differences between the third embodiment and the first and second embodiments will be discussed here. Components identical or similar to ones in the first embodiment are each labeled in FIG. 3, and in the description of the third embodiment, with reference characters incremented by 200, and reference is explicitly made to their description in the first embodiment unless otherwise indicated by the description. Components identical or similar to ones in the second embodiment are each labeled in FIG. 3, and in the description of the third embodiment, with reference characters incremented by 100, and reference is explicitly made to their description in the second embodiment unless otherwise indicated by the description.

The third embodiment differs from the first two embodiments in that it also comprises climate chamber 256 in addition to climate chamber 236, and furthermore that a climate chamber 272 that surrounds construction material transfer portion 254 can optionally be provided. With a functionality similar to that in the case of climate chambers 36 and 156, climate chamber 272 comprises a regulating unit or control unit 274 and a sensor arrangement 276, connected to regulating unit or control unit 274 for apparatus parameter transfer, having a humidity sensor and a temperature sensor in the interior of climate chamber 272. Climate chamber 272 furthermore comprises a monitoring opening 280, equipped with a door 278, for monitoring filament 232, said opening being sealed, preferably via a rubber lip, with respect to a wall 282 of climate chamber 272. A contact switch 284, connected to regulating unit or control unit 274 for apparatus parameter transfer, is preferably arranged on door 278, signal evaluation at contact switch 284 by regulating unit or control unit 274 corresponding to signal evaluation at contact switch 50 by regulating unit or control unit 46.

Regulating unit or control unit 274 regulates or controls the humidity and temperature in the interior of climate chamber 272 on the basis of signals of sensor arrangement 276.

The functionality of regulating unit or control unit 274 in interaction with contact switch 284, climate chamber 272, and the sensors of sensor arrangement 276 corresponds to the functionality of regulating unit or control unit 46 in interaction with contact switch 50, climate chamber 38, and the sensor of sensor arrangement 48 of the first embodiment. Contact switch 284, as well as the temperature sensor and humidity sensor of sensor arrangement 276, each constitute an apparatus parameter sensor that transfers the respective apparatus parameters to regulating unit or control unit 274, which in turn transfers the apparatus parameters to regulating unit or control unit 246.

The functionality of regulating unit or control unit 266 differs from that of regulating unit or control unit 166 of the second embodiment in that it does not regulate or control the execution of the fused deposition modeling method, that function being taken on by regulating unit or control unit 246. Regulating unit or control unit 274 likewise does not regulate or control the fused deposition modeling method. Like regulating unit or control unit 274, regulating unit or control unit 266 transfers the apparatus parameters conveyed to it to regulating unit or control unit 246 without comparing them with setpoint ranges.

Regulating unit or control unit 246 compares both apparatus parameters that are transferred directly to it from apparatus parameter sensors 250, and the sensors of sensor arrangement 248, connected to it, as well as the apparatus parameters that are transferred to it from regulating unit or control unit 274 and regulating unit or control unit 266, with a setpoint range predetermined for each of those apparatus parameters. If one of those apparatus parameters is outside the setpoint range predetermined for it, regulating unit or control unit 246 then prevents the fused deposition modeling method from beginning, or interrupts a fused deposition modeling method that is already running.

In all embodiments, it is preferred that during constitution of the component, at least one of regulating unit or control units 46; 155; 246, 266, 274 regulate or control, in the climate chamber arrangement portion 38; 156; 238, 156, 272 regulated or controlled by it with respect to climate parameters, the respective climate parameter values, for instance the temperature in the interior of the climate chamber arrangement portion and/or the humidity of the internal gas medium in the interior of the climate chamber arrangement portion, to a respective production climate parameter setpoint, for example a production climate parameter setpoint of the temperature in the interior of the climate chamber arrangement portion and/or a production climate parameter setpoint of the humidity of the internal gas medium in the interior of the climate chamber arrangement portion. These production climate parameter setpoints can be adjusted experimentally to optimal material properties of the component.

In a preparation phase of constitution of the component portion, for instance between two production cycles in each of which a component is constituted, it is preferred that at least one of regulating unit or control units 46; 166; 246, 266, 274 regulate or control, in the climate chamber arrangement portion 38; 156; 238, 156, 272 regulated or controlled by it with respect to climate parameters, the respective climate parameter values, for instance the temperature in the interior of the climate chamber arrangement portion and/or the humidity of the internal gas medium in the interior of the climate chamber arrangement portion, to a respective preparation climate parameter setpoint, for instance a preparation climate parameter setpoint of the temperature in the interior of the climate chamber arrangement portion and/or a preparation climate parameter setpoint of the humidity of the internal gas medium in the interior of the climate chamber arrangement portion. These preparation climate parameter setpoints can be different from the respective corresponding production climate parameter setpoints and can represent, for instance, a compromise between energy expended per unit time in order to maintain those preparation setpoints in the respective climate chamber arrangement portion, and the time required to allow a component to again be constituted in apparatus 20, 120, 200 under the optimal production setpoint conditions. The preparation climate parameter setpoints and production climate parameter setpoints can be stored in the respective control units 46; 166; 246, 266, 274.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-12. (canceled)

13. An apparatus for executing a fused deposition modeling method for constituting at least one component portion or component using a fusible construction material, encompassing: a layering tool for constituting at least the component portion or component by constituting layers of molten construction material in a predetermined pattern; a construction material manipulation portion; and a climate chamber arrangement; at least a sub-portion of the construction material manipulation portion being surrounded by a climate chamber arrangement portion of the climate chamber arrangement; the climate chamber arrangement being configured to adjust, at least locally, a climate parameter in an interior of the climate chamber arrangement portion; and the apparatus being configured to perform a manipulation of the construction material in the climate chamber arrangement portion,
wherein the climate parameter is a humidity of an internal gas medium in the interior of the climate chamber arrangement portion.

14. The apparatus according to claim 13, wherein the climate chamber arrangement is configured to adjust, at least locally, at least one further climate parameter in the interior of the climate chamber arrangement portion; particularly preferably, the climate chamber arrangement is configured to regulate at least one of the climate parameters and/or further climate parameters adjusted in the interior of the climate chamber arrangement portion respectively to an associated climate parameter setpoint, such that each of the climate parameter setpoints can have a value that can differ from the value of the associated climate parameter outside the climate chamber arrangement portion.

15. The apparatus according to claim 13, wherein the manipulation of the construction material encompasses or is storage and/or desiccation and/or adjustment of the moisture content of and/or regulation of the moisture content of and/or transportation and/or reshaping and/or melting and/or extrusion of the construction material, and/or constitution of a semi-finished product from the construction material, and/or application of the molten construction material in a predetermined pattern.

16. The apparatus according to claim 14, wherein the climate parameter or the at least one further climate parameter is respectively selected from: humidity of the internal gas medium in the interior of the climate chamber arrangement portion; temperature in the interior of the climate chamber arrangement portion; pressure of the internal gas medium in the interior of the climate chamber arrangement portion; and composition of the internal gas medium in the interior of the climate chamber arrangement portion.

17. The apparatus according to claim 13, wherein the construction material manipulation portion
encompasses a construction material storage portion for storing the construction material, or a semi-finished product produced therefrom, as a starting material for use for the fused deposition modeling method; and/or
encompasses a component production portion furnishing a space for constituting the component portion or the component, in which the component portion or the component is constituted using the fused deposition modeling method utilizing the layering tool and the construction material; and preferably
encompasses a construction material transfer portion that is arranged between the construction material storage portion and the component production portion and is configured for transportation of the construction material, or of the semi-finished product produced therefrom, between the construction material storage portion and the component production portion;
these preferably constituting, each individually or in any combination, the sub-portion of the construction material manipulation portion.

18. The apparatus according to claim 17, wherein the component production portion and/or the construction material storage portion and/or the construction material transfer portion are surrounded by the climate chamber arrangement portion, or by a further climate chamber arrangement portion, of the climate chamber arrangement.

19. The apparatus according to claim 17, wherein the component production portion is surrounded by the climate chamber arrangement portion, or by a further climate chamber arrangement portion, of the climate chamber arrangement, that climate chamber arrangement portion having a wall that comprises a reopenable and reclosable removal opening for removing the constituted component portion or constituted component from that climate chamber arrangement portion.

20. The apparatus according to claim 17, wherein the component production portion is surrounded by the climate chamber arrangement portion, or by a further climate chamber arrangement portion, of the climate chamber arrangement, that climate chamber arrangement portion comprising a wall that comprises a construction material delivery opening, the construction material delivery opening being configured to permit transportation of construction material into an interior of that climate chamber arrangement portion and to prevent transportation of the internal gas medium from the interior of that climate chamber arrangement portion into its exterior space from which it is separated by the wall, and to prevent transportation of an external gas medium from its exterior space into the interior of that climate chamber arrangement portion.

21. The apparatus according to claim 17, wherein the construction material storage portion is surrounded by the climate chamber arrangement portion, or by a further climate chamber arrangement portion, of the climate chamber arrangement, that climate chamber arrangement portion having a wall that comprises a reopenable and reclosable loading opening for loading the construction material storage portion with construction material.

22. The apparatus according to claim 17, wherein the construction material storage portion is surrounded by the climate chamber arrangement portion, or by a further climate chamber arrangement portion, of the climate chamber arrangement, that climate chamber arrangement portion having a wall that comprises a construction material discharge opening, the construction material discharge opening being configured to permit transportation of construction material from an interior of that climate chamber arrangement portion and to prevent transportation of the internal gas medium from the interior of that climate chamber arrangement portion into its exterior space from which it is separated by the wall, and to prevent transportation of an external gas medium from its exterior space into the interior of that climate chamber arrangement portion.

23. The apparatus according to claim 13, wherein the construction material is an engineering plastic, in particular a thermoplastic, particularly preferably a polyamide.

24. The apparatus according to claim 13, wherein the apparatus encompasses a regulating unit and/or control unit for regulating and/or controlling the execution of the fused deposition modeling method, and at least one apparatus parameter sensor configured for direct or indirect transfer of an apparatus parameter, detected by it, to the regulating unit and/or control unit,
the regulating unit and/or control unit being configured to compare each of the transferred apparatus parameters with a predetermined setpoint range for that apparatus parameter, and to prevent the fused deposition modeling method from beginning, and/or to interrupt the fused deposition modeling method, if one of the transferred apparatus parameters is outside the setpoint range for that apparatus parameter.
